(19) United States
(12) Patent Application Publication
(10) Pub. No.: US 2015/0149374 A1
(43) Pub. Date: May 28, 2015

(54) RELATIONSHIP CIRCLE PROCESSING METHOD AND SYSTEM, AND COMPUTER STORAGE MEDIUM

(71) Applicant: Tencent Technology (Shenzhen) Company Limited, Shenzhen (CN)

(72) Inventors: Yuhuang Li, Shenzhen (CN); Yuewen Liu, Shenzhen (CN); Peng He, Shenzhen (CN); Junming Mai, Shenzhen (CN); Chuan Chen, Shenzhen (CN); Weihua Chen, Shenzhen (CN)

(21) Appl. No.: 14/400,405

(22) PCT Filed: Apr. 8, 2013
(86) PCT No.: PCT/CN2013/073853

§ 371 Date: Nov. 11, 2014

(30) Foreign Application Priority Data
May 15, 2012 (CN) 201210150076.3

(51) Int. Cl. G06Q 50/00; G06Q 10/00

(52) U.S. Cl. CPC G06Q 50/01; G06Q 10/00
USPC 705/319

(57) ABSTRACT

Disclosed are a method, system and computer storage medium for processing relationship circle. The method includes: acquiring subgroups from a relationship circle; extracting subgroup attributes shared between members of the relationship circle from the subgroups; obtaining at least one recognition result from the subgroup attributes shared between members of the relationship circle; and mapping the at least one recognition result to the relationship circle. The system includes: a subgroup acquisition module, configured to acquire subgroups within a relationship circle; an extraction module, configured to extract subgroup attributes shared between members of the relationship circle from the subgroups; and a mapping module, configured to obtain at least one recognition result by analyzing the subgroup attributes shared between members of the relationship circle and map the at least one attribute recognition result to the relationship circle. Through the above solutions dynamic relationship circle mapping can be implemented.

### TECHNICAL FIELD

The present invention relates to Internet technology, particularly, to a method and a system for processing relationship circles, and memory storage medium.

### TECHNOLOGICAL BACKGROUND

With the unceasing development of internet applications, instant messengers and social networks have come to be an essential tool that is widely employed by users both in their daily lives and at work. Through instant messaging and social networks, increasingly more users are creating relationship chains by sharing information and contacts which results in the creation of a larger relationship circle by multiple users.

Every type of diverse relationship circle is commonly frequented by users with similar attributes, for example, the inter-relationship between classmates or colleagues, with each circle having a relevant name, information tags, etc. denoting attribute information of the relationship circle. Since attributes of relationship circle members are often displayed based on similarities between individual users, when changes in attribute information occur they must be manually edited, thus, causing the relationship circle to have flaws regarding its flexibility.

### SUMMARY

In light of this, it is necessary to address the technological question of this lack of flexibility in existing methods as well as provide a method for processing relationship circles that can carry out dynamic mapping of the relationship circle.

Furthermore, it is also necessary to provide a system for processing relationship circles that can carry out dynamic mapping of the relationship circle.

Moreover, it is also necessary to provide a computer storage medium that can carry out dynamic mapping of the relationship circle.

The method for processing relationship circles includes: acquiring subgroups within a relationship circle; extracting subgroup attributes shared between members of the relationship circle from the subgroups; obtaining at least one recognition result by analyzing the subgroup attributes shared between members of the relationship circle; and mapping the at least one recognition result to the relationship circle.

The system for processing relationship circles includes: a subgroup acquisition module, configured to acquire subgroups within a relationship circle; an extraction module, configured to extract group attributes shared between members of the relationship circle from the subgroups; and a mapping module, configured to obtain at least one recognition result by analyzing the attributes of the subgroups shared between members of the relationship circle, and map the at least one recognition results to the relationship circle.

The computer storage medium for storing computer-executable instructions, the computer-executable instructions are to be executed to perform a method for processing relationship circles, the method comprising: acquiring subgroups within a relationship circle; extracting attributes of the subgroups shared between members of the relationship circle from the subgroups; obtaining at least one recognition result by analyzing the attributes of the subgroups shared between members of the relationship circle; and mapping the at least one recognition results to the relationship circle.

According to the aforementioned method, system and computer storage medium for processing relationship circles, subgroup attributes shared between members of the many subgroups are extracted, and then the attribute recognition result are obtained from the subgroup attributes shared between members. And the attribute recognition result can be mapped to the relationship circle. Therefore, dynamic relationship circle mapping can be implemented, thereby making the relationship circle able to adapt to dynamic changes in all types of attribute information of the members of the relationship circle, thereby increasing flexibility.

### BRIEF DESCRIPTION OF THE DRAWINGS

FIG. 1 is a flow chart depicting a method for processing a relationship circle according to an embodiment of the present disclosure;

FIG. 2 is a flow chart depicting a method for obtaining the attribute recognition result by analyzing the attributes of the subgroups shared between members of the relationship circle and mapping the recognition result to the relationship circle according to an embodiment of the present disclosure;

FIG. 3 depicts the attribute recognition result as well as corresponding matching weight determined through word segmentation of subgroup attributes as shown in FIG. 2;

FIG. 4 is a flow chart depicting a method for obtaining the attribute recognition result by analyzing the attributes of the subgroups shared between members of the relationship circle and mapping the recognition results to the relationship circle according to another embodiment of the present disclosure;

FIG. 5 depicts a flow chart outlining the method by which attribute recognition result is extracted based on the matching weights and the attribute recognition result is then mapped to the relationship circle according to an embodiment of the present disclosure;

FIG. 6 depicts a structural schematic of a system for processing a relationship circle according to an embodiment of the present disclosure;

FIG. 7 depicts a structural schematic of a mapping module according to an embodiment of the present disclosure; and

FIG. 8 depicts a structural schematic of a recognition unit according to an embodiment of the present disclosure.

### DETAILED DESCRIPTION

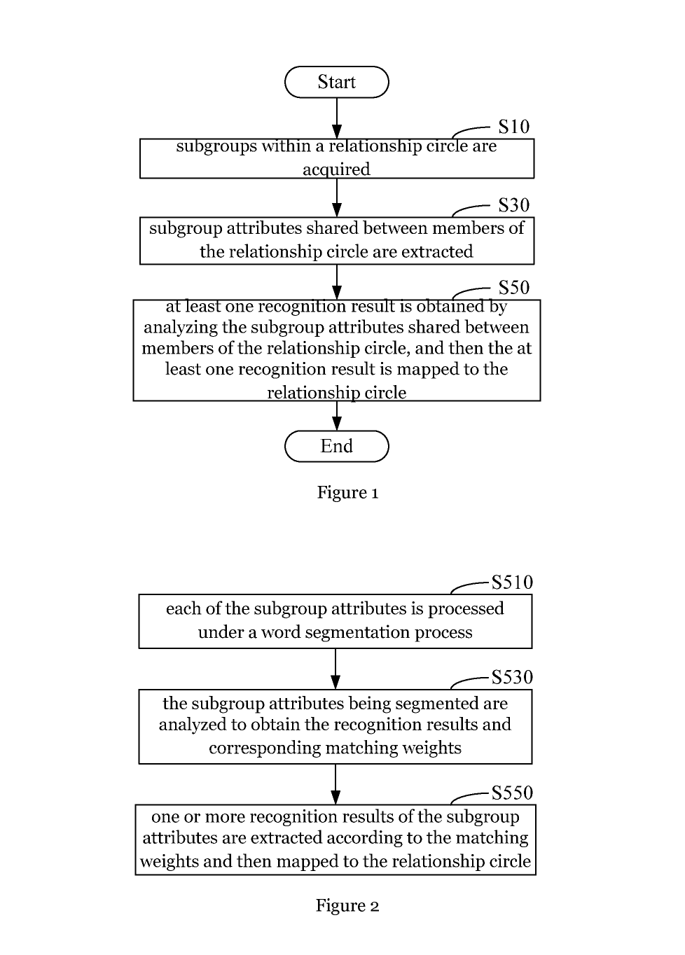

As is shown in FIG. 1, the method for processing relationship circles according to an embodiment of the present disclosure includes the following steps:

In step S10, subgroups within a relationship circle are acquired.

In this embodiment, a subgroup consists of a specific category of users. In a preferred embodiment, a subgroup can be in a form of a relationship chain. For example, the relationship circle can contain a group of users who are classmates. The relationship circle could also contain a group of users who are colleagues. Members of the relationship circle can make up any number of relationship chains, for example, relationships can span between many members of the relationship circle such as in the case of the friendship between member A and member B and the friendship between member B and member C can create a relationship chain consisting of the relationship between members A and B and members B and C. The relationship chain within the relationship circle includes the relationship chain resulting from instant messaging contacts as well as relationships chains derived from social websites.

In step S30, subgroup attributes shared between members of the relationship circle are extracted.

In this embodiment, the subgroup attributes are extracted from subgroups. The aforementioned subgroup attributes include names and classification information of the subgroups, etc. For example, in the relationship chain between member A and member C, member C's instant messenger will affiliate member A with the subgroup attribute denoting them as classmates, whereas in member A's instant messenger, member C will be affiliated with the subgroup identifying them as college classmates. In the relationship chain existing between member B and member C, member C's social network will affiliate member B with the college classmates subgroup. In member B's social network, member C will be affiliated with the university subgroup. At this time, many subgroup attributes will be extracted from subgroups distinguishing “classmates”, “college classmates”, and “university.”

In another embodiment, the possibility of many subgroup attributes being extracted from the existing subgroups of a relationship circle is very high. To further facilitate follow-up procedures, the subgroup attributes and an identification of the relationship circle, as well as identifications of users can be correlated. Namely, the many subgroup attributes extracted from the diverse subgroups, the identification of the relationship circle, and the identification of a user in the relationship circle, have a many-to-one relational mapping between them. The identification of the user in the relationship circle makes up the relationship circle's display icons.

In step S50, at least one recognition result is obtained by analyzing the subgroup attributes shared between members of the relationship circle, and then the at least one recognition result is mapped to the relationship circle.

In this embodiment, the subgroup attributes shared between relationship circle members represent all of the aforementioned common attributes between the members. The attributes of the relationship circle can be analyzed based on the subgroup attributes and then mapped to the relationship circle, thereby establishing relational mapping between the attribute recognition result and the relationship circle and adding a corresponding name, attribute information, etc. to the relationship circle. By the above method, dynamic mapping of the relationship circle can be implemented which makes the name and attribute of the relationship circle adapt to the dynamic changes of the members, thereby increasing flexibility.

As is shown in FIG. 2, in one embodiment, the specific process of the aforementioned step S50 includes:

In step S510, each of the subgroup attributes is processed under a word segmentation process.

For example, in this embodiment, through various operations of word segmentation of the subgroup attributes, corresponding keywords are acquired for each subgroup. For example, the subgroup attribute “university classmates” contains both the keywords “university” and “classmates.” In carrying out the word segmentation process for subgroup attributes, the follow-up subgroup attributes recognition procedure will benefit by achieving a greater level of accuracy.

In step S530, the subgroup attributes being segmented are analyzed to obtain the recognition results and corresponding matching weights.

In this embodiment, the many keywords obtained through word segmentation of subgroup attributes are filtered to determine the recognition results of the relationship circle and corresponding matching weights. The aforementioned matching weight is used to indicate the matching degree between the recognition result and the corresponding subgroup attribute.

In one embodiment, the specific process of the aforementioned step S530 may include: differentiating the keywords of the subgroup attributes through a classification model and obtaining recognition results of the subgroup attributes as well as matching weights between the recognition results and subgroup attributes.

In the present embodiment, a pre-made classification model is used as a classifier to differentiate the subgroup attributes, with the classification model serving to distinguish shared characteristics and then obtain recognition results based on the above-mentioned characteristics. The above-mentioned classification model is constructed based on use of various types of prior information. The above-mentioned prior information includes classmates, colleagues, family members, etc. Corresponding diagnostic properties of the classification model are set up based on various types of prior information. The classification model consists of fixed input variables and output variables, among which, the input variables include the subgroup attributes as well as corresponding identification of the relationship circle and indications of the users. The output variables include the recognition results, the matching weights and corresponding identification of relationship circle and identifications of users.

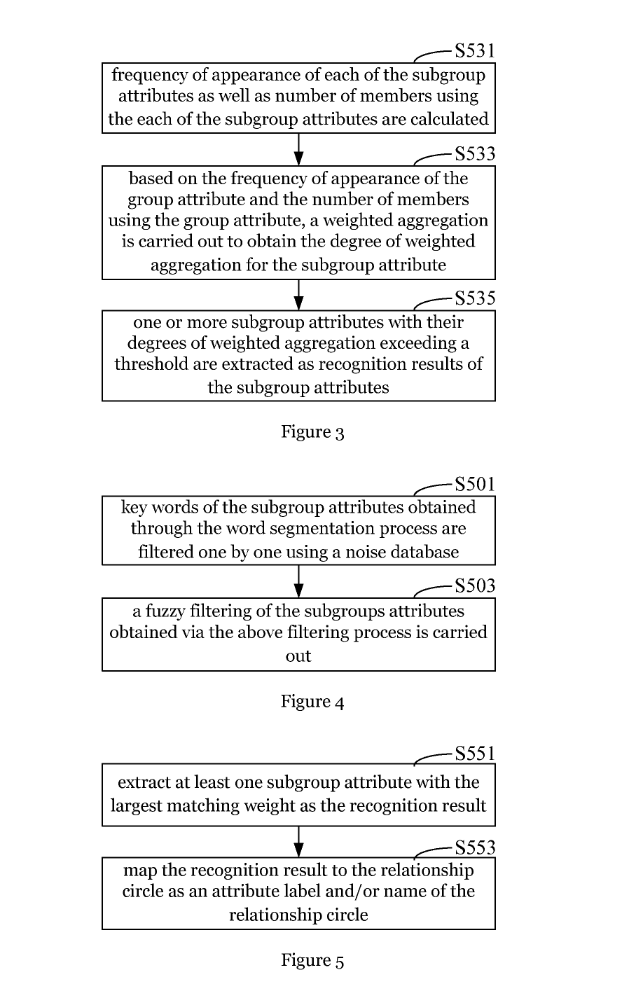

As seen in FIG. 3, in another embodiment, the specific process of the above-mentioned step S530 includes:

In step S531, frequency of appearance of each of the subgroup attributes as well as number of members using the each of the subgroup attributes are calculated.

In this embodiment, aside from the classification model carrying out the differentiation process through use of prior information, since the classification model has a limited capability to determine recognition results of attributes, the recognition results can also be determined through aggregation logic. These two methods can also be simultaneously carried out. Furthermore, since aggregation logic is capable of differentiating a comparatively wide range of subgroup attributes, it is possible to directly carry out analysis through aggregation logic, rather than by using the classification model.

Specifically, for each individual subgroup attribute, the frequency of the appearance of the subgroup attribute as well as the number of members using the subgroup attribute are calculated. For example, the subgroup attributes of the relationship circle extracted include colleagues, TC, TX, etc. with the calculated frequency of appearance of all the subgroup attributes being 200 times, with the number of members using all the subgroup attribute being 30 members. Amongst these calculated results, the frequency of appearance of “colleagues” is 160 times, and 20 members used this subgroup attribute of colleagues; the frequency of appearance of “TC” is 20 times, with two members using the TC subgroup attribute; and the frequency of appearance of “TX” is 2 times, with 8 members having used the TX subgroup attribute.

In step S533, based on the frequency of appearance of the group attribute and the number of members using the group attribute, a weighted aggregation is carried out to obtain the degree of weighted aggregation for the subgroup attribute.

In this embodiment, through a weighted aggregation process on countless data corresponding to the many subgroup attributes of the relationship circle, the attributes of the relationship circle can be obtained, with the above-mentioned attribute indicating the relationship between members of the relationship circle, namely, their relationship attributes.

During the weighted aggregation process, the corresponding degree of weighted aggregation of each subgroup attribute is calculated based on frequency of appearance the subgroup attribute as well as number of members using the subgroup attribute. The aforementioned degree of weighted aggregation of a subgroup attribute is used to show how frequent the subgroup attribute is used by members of the relationship circle. For example, in regards to the subgroup attribute “colleagues”, the degree of weighted aggregation equals to a*(160/200)+b*(20/30), wherein, a and b are parameters obtained by regression analysis.

In step S535, one or more subgroup attributes with their degrees of weighted aggregation exceeding a threshold are extracted as recognition results of the subgroup attributes. The degree of weighted aggregation of a subgroup attribute extracted serves as the corresponding matching weight of the subgroup attribute extracted.

In this embodiment, one or more subgroup attributes with their degree of weighted aggregation exceed a threshold are extracted as recognition results of the subgroup attributes after calculating the degree of weighted aggregation for each corresponding subgroup attribute.

As shown in FIG. 4, in another embodiment, the method includes the following step before the aforementioned step S530:

In step S501, key words of the subgroup attributes obtained through the word segmentation process are filtered one by one using a noise database.

In this embodiment, in the subgroup attributes extracted from the subgroups there exists a certain amount of noise. The aforementioned noise includes offensive language, strings composed of simple symbols, and single characters with indefinite meanings. It is necessary to carry out filtering of the subgroup attributes and to eliminate such noise in order to produce clear and simple subgroup attributes. Firstly, in order to produce accurate subgroup attributes, single characters and symbols will be eliminated from the subgroup attributes. Single characters and symbols with indefinite meanings, unclear words, and offensive language have been stored in a noise database beforehand. In this method, the presence of noise will be compared with the noise database and eliminated from the subgroup attributes.

In step S503, a fuzzy filtering of the subgroups attributes obtained via the above filtering process is carried out.

In this embodiment, a pre-established fuzzy match model will be used to filter out strings of characters with indefinite meanings from the subgroup attributes. Both fuzzy filtering and precise filtering can be carried out based on need, or can be carried out using either fuzzy or precise filtering alone. When carrying out both fuzzy and precise filtering processes, the fuzzy filtering could follow the precise filtering in order to increase efficiency.

In step S550, one or more recognition results of the subgroup attributes are extracted according to the matching weights and then mapped to the relationship circle.

In this embodiment, the one or more recognition results of the subgroup attributes are extracted based on the magnitude of the matching weights. Thereby, the extraction of the recognition results brings about mapping between the relationship circle and the recognition results.

Additionally, information regarding activities in a subgroup can also be obtained. The information regarding activities can also assist in obtaining accurate recognition results. The aforementioned information regarding activities can consist of degree of activity, active time, etc. For example, the recognition results may include the subgroup attributes of “classmates” and “colleagues”, which are the subgroup attributes with the largest matching weights. And if the active time of the subgroup is work time, the subgroup “colleagues” will be extracted as a recognition result and then be mapped to the relationship circle.

As shown in FIG. 5, in an embodiment, the specific process involved in step S550 includes:

Step S551, extract at least one subgroup attribute with the largest matching weight as the recognition result.

Step S553, map the recognition result to the relationship circle as an attribute label and/or name of the relationship circle.

In this embodiment, the attribute label and/or name obtained based on the recognition result are added to the relationship circle and displayed to users. Therefore, the users are able to accurately identify types and relationship attributes of the members of the relationship circle.

The present invention also offers a computer storage medium that can store executable computer commands. The aforementioned executable computer commands serve to carry out the above-mentioned method for processing relationship circles. The precise method by which the computer executable commands stored in the computer storage medium, such as the execution of the relationship circle processing method, will not be further addressed.

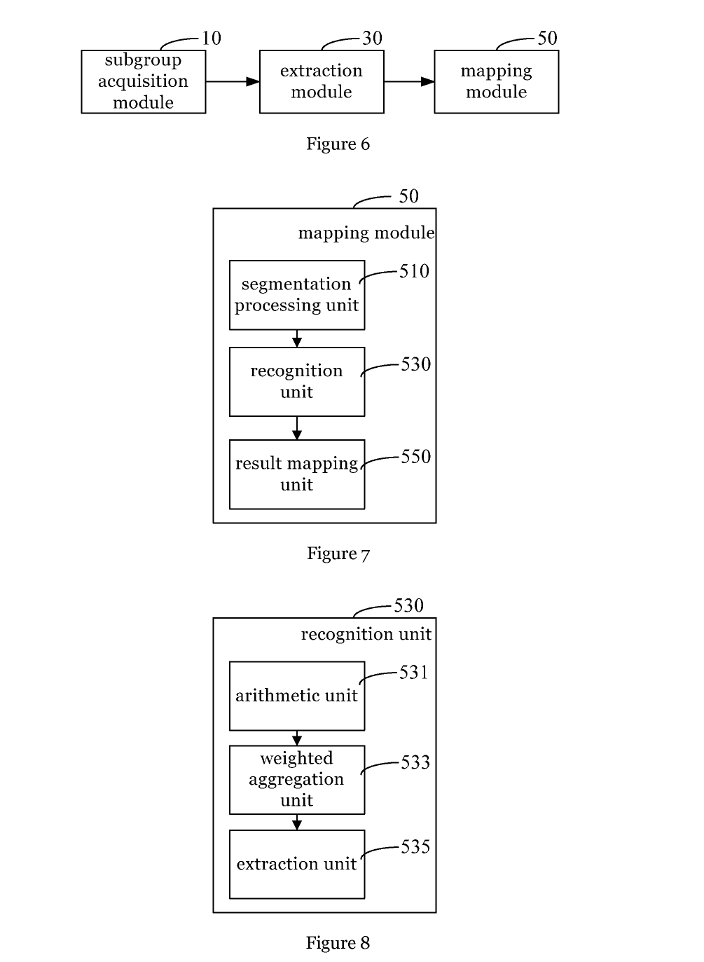

Shown in FIG. 6 is a system for processing relationship circles, which includes a subgroup acquisition module 10, an extraction module 30, and a mapping module 50.

The subgroup acquisition module 10 serves to acquire subgroups within the relationship circle.

In this embodiment, a subgroup consists of a certain type of users. In a preferred embodiment, a subgroup can be in a form of a relationship chain, for example, a relationship circle could consist of a group of members with the relation of classmates, or of a group of members with the relation of colleagues. A certain number of relationship chains exist between members in the relationship circle. For example, amongst the many members of the relationship circle, member A and member B share a friendship relation and members B and C share a friendship relation, with the relationship circle thereby consisting at least of the relationship chains between members A and B, and members B and C. The relationship chain within the relationship circle includes the chain that exists in the instant messenger as well as social network relationship chains.

The extraction module 30 serves to extract subgroup attributes shared between members of the relationship circle from the subgroups.

In this embodiment, the extraction module 30 carries out the extraction of subgroup attributes, which includes names and classification information of the subgroups, etc. For example, in the relationship chain between member A and member C, member C is affiliated with the subgroup attribute of “classmate” in member A's instant messenger, and in member C's instant messenger, member A is affiliated with the subgroup attribute of “university classmate”. In the relationship chain between member B and member C, member B is affiliated with the subgroup attribute of “university classmates” in member C's social network, and in member B's social network, member C is affiliated with the subgroup attribute of “university.”

In another embodiment, the possibility of many subgroup attributes being extracted from existing subgroups within the relationship circle by the extraction module 30 is very high. To further the facilitate follow-up procedures, affiliations will be made amongst subgroup attributes, the identification of the relationship circle, and identifications of relationship circle users, namely from the existing many-to-one mapping relations between the many subgroup attributes, the identification of the relationship circle, and the identifications of the relationship circle users extracted from various subgroups. The identification of the user in the relationship circle makes up the relationship circle's display icons.

The mapping module 50 is used to obtain at least one recognition result by analyzing the subgroup attributes shared between members of the relationship circle, and then to map the at least one recognition to the relationship circle.

In this embodiment, subgroup attributes shared between relationship circle members are indicated by all of the aforementioned common attributes between the members. Accordingly, the attributes of the relationship circle can be analyzed based on the subgroup attributes and then mapped to the relationship circle by the mapping module 50, thereby establishing relational mapping between the attribute recognition result and the relationship circle and adding a corresponding name, attribute information, etc. to the relationship circle. By the above method, dynamic mapping of the relationship circle can be implemented which makes the name and attribute of the relationship circle adapt to the dynamic changes of the members, thereby increasing flexibility.

As shown in FIG. 7, in one embodiment, the aforementioned mapping module 50 includes a segmentation processing unit 510, a recognition unit 530, and a result mapping unit 550.

The segmentation processing unit 510 is configured to carry out a segmentation process on the subgroup attributes.

In this embodiment, through various operations of word segmentation, the word segmentation process module 50 carries out a word segmentation process of each subgroup attribute respectively to acquire corresponding keywords. For example, the subgroup attribute “university classmates” contains the two keywords “university” and “classmates.” The word segmentation process of the subgroup attributes is beneficial in the follow-up process by increasing the accuracy of subgroup attribute recognition.

The recognition module S530 is used to obtain one or more recognition results as well as corresponding matching weights by analyzing the key words of the subgroup attributes obtained through the word segmentation process.

In this embodiment, the many keywords are obtained through word segmentation. The recognition module 530 serves to filter the many keywords and obtain one or more recognition results and corresponding matching weights. The aforementioned matching weight is used to indicate the matching degree between the recognition result and the corresponding subgroup attribute.

In one embodiment, the recognition module 530 is also used to differentiate the subgroup attributes through a classification model and obtaining one or more recognition results of the subgroup attributes as well as corresponding matching weights between the recognition results and subgroup attributes.

In this embodiment, the recognition module 530 pre-establishes a classification module to serve as a classifier to differentiate the subgroup attributes, with the classification model serving to distinguish shared characteristics and then obtain recognition results based on the above-mentioned characteristics. The above-mentioned classification model is constructed based on use of various types of prior information. The above-mentioned prior information includes classmates, colleagues, family members, etc. Corresponding diagnostic properties of the classification model are set up based on various types of prior information. The classification model consists of fixed input variables and output variables, among which, the input variables include the subgroup attributes as well as corresponding identification of the relationship circle and indications of the users. The output variables include the recognition results, the matching weights and corresponding identification of relationship circle and identifications of users.

As shown in FIG. 8, in another embodiment, the aforementioned recognition module 530 includes an arithmetic unit 531, a weighted aggregation unit 533, and an extraction unit 535.

The arithmetic unit 531 is used to calculate the frequency of appearance each of the subgroup attributes as well as number of members using each of the subgroup attributes.

In this embodiment, aside from the classification model carrying out the differentiation process through use of prior information, since the classification model has a limited capability to determine recognition results of attributes, the recognition results can also be determined through aggregation logic. These two methods can be carried out simultaneously. Furthermore, due to the fact that the capabilities of aggregation logic are comparatively more extensive, recognition can also be carried out directly through aggregation logic, without using the classification model.

Specifically, the arithmetic unit 531 calculates for each individual subgroup attribute frequency of appearance of the subgroup attribute as well as number of members using the aforementioned subgroup attribute. For example, the extracted subgroup attributes of a relationship circle might include colleagues, TC, TX, etc. The arithmetic unit 531 calculates the frequency of appearance for all subgroup attributes as appearing a total of 200 times, which applies to all of the subgroup attributes of the relationship circle's 30 members. Amongst them, 160 appearances represent “colleagues”, with 20 members having used this subgroup attribute; 20 represent “TC”, a subgroup attribute having been used by 2 members; and 20 represent “TX”, a subgroup attribute having been used by 8 members.

In this embodiment, the weighted aggregation unit 533 carries out the weighted aggregation process on a large amount of data collected corresponding to the many subgroup attributes within the relationship circle so as to analyze all subgroup attributes possessed by the relationship circle, as mentioned above, thereby indicating the subgroup attributes shared between relationship circle members, namely, their relationship attributes.

Based on the frequency of the appearance of the subgroup attribute and the number of members using the subgroup attribute calculated, the weighted aggregation unit 533 determines the corresponding degree of weighted aggregation of each subgroup attribute. The aforementioned degree of weighted aggregation is used to indicate how frequent the subgroup attribute is used by members of the relationship circle. For example, in regards to the subgroup attribute of “colleagues”, the degree of weighted aggregation equals to a*(160/200)+b*(20/30), amongst which, a and b are parameters obtained through regression analysis.

The extraction unit 535 is used to extract one or more subgroup attributes with their degrees of weighted aggregation exceeding a threshold as attribute recognition results, and to extract the degree of weighted aggregation of a subgroup attribute extracted as the corresponding matching weight.

In this embodiment, the extraction unit 535 extracts one or more subgroup attributes with their degrees of weighted aggregation exceeding the preset threshold as attribute recognition results after calculating the corresponding degree of weighted aggregation of each subgroup attribute.

In another embodiment, the aforementioned mapping module 50 also includes a filter. The aforementioned filter is used to filter characters in the subgroup attributes obtained through segmentation individually based on a noise database, and to carry out a fuzzy filtration of the subgroup attributes obtained in the filtration process.

In this embodiment, there is a certain amount of noise that exists in the subgroup attributes extracted from the subgroups. The aforementioned noise includes vocabulary of an offensive nature, strings of simple characters, and single characters with no clear meaning, etc. It is necessary to carry out filtration of noise in the subgroup attributes to eliminate noise and produce simple subgroup attributes. The filter first carries out precise filtering of the subgroup attributes and eliminates single characters and symbols. Vocabulary constituting single characters, symbols without clear meanings, and vocabulary of an offensive nature will be stored in a noise database beforehand. Noise in the subgroup attributes will be eliminated through comparison with the noise database.

A fuzzy match model will be pre-installed in the noise database to carry out fuzzy match filtration and eliminate strings of words without clear meanings in the subgroup attributes. Precise filtration and fuzzy filtration can both be carried out based on need or only fuzzy filtration or precise filtration can be carried out alone. If carrying out both fuzzy and precise filtration, the fuzzy filtration should take place following the precise filtration in order to increase the efficiency of the process.

The result mapping unit 550 is used to extract one or more recognition results according to corresponding matching weights and to map the extracted one or more recognition results to the relationship circle.

In this embodiment, the result mapping unit 550 extracts one or more recognition results of the subgroup attributes based on the magnitudes of the corresponding matching weights and then, in accordance with the extracted recognition results, initiates mapping between the relationship circle and the one or more recognition results.

In another embodiment, the result mapping unit 550 is also used to extract the one or more subgroup attribute with the largest matching weights and then map the one or more recognition results to the relationship circle as attribute labels and/or names of the relationship circle.

In this embodiment, the result mapping unit 550 serves to add attribute labels and/or names to the relationship circle accordingly, while also to display them to the user, thereby allowing the user to be accurately informed of all of the aforementioned corresponding categories and relationship attributes of members of the relationship circle.

Technical professionals can understand the implementation of all or part of the process of the aforementioned embodiment and through use of a computer program can command the related hardware to complete the task. Said computer program can be read from a readable memory storage medium. Such a program can include the aforementioned computer program embodiment method. Amongst which, said computer storage memory medium can be a floppy disk, compact disk, read-only memory (ROM), or random access memory (RAM), etc.

The aforementioned method and system, computer storage medium for processing relationship circle, as well as the process by which numerous attributes that are shared between members are extracted from members' shared subgroups and then from which recognition results are determined, and the method by which these results are then mapped to the relationship circle, thereby implementing dynamic mapping and enabling the capabilities of the relationship circle to adapt to various types of changes in members and attribute information, serve to increase overall flexibility.

The above said embodiment expressed several methods by which the present invention can be implemented, its description being relatively specific and detailed, however, it is understood that it does not consequently limit the scope of the present invention. It should be noted that those of ordinary skill in the art, without departing from the concept of the premise of the present invention, can still make additional changes and improvements which fall within the scope of the protection of the present invention. Consequently, the scope of patent protection for the present invention as well as the attached appended claims shall prevail.

1. A computer implemented method for processing relationship circles, comprising:
acquiring subgroups from a relationship circle;
extracting subgroup attributes shared between members of the relationship circle from the subgroups;
obtaining at least one recognition result from the subgroup attributes shared between members of the relationship circle; and
mapping the at least one recognition result to the relationship circle.

2. The method according to claim 1, wherein the subgroup is in form of a relationship chain; a number of relationship chains exist between the members of the relationship circle; and the relationship chains comprises relationship chains existing in instant messengers and online social networks.

3. The method according to claim 1, wherein obtaining the at least one recognition result from the subgroup attributes shared between members of the relationship circle and mapping the at least one recognition result to the relationship circle comprises:
carrying out a word segmentation process on the subgroup attributes;
obtaining the at least one recognition result and corresponding matching weight by analyzing subgroup attributes being segmented;
extracting at least one recognition result according to the corresponding matching weight; and
mapping the at least one recognition result extracted to the relationship circle.

4. The method according to claim 3, further comprising before obtaining the at least one recognition result and corresponding matching weight by analyzing subgroup attributes being segmented:
filtering each character in the subgroup attributes being segmented using a noise database; and
carrying out a fuzzy filtering of the subgroup attributes being filtered.

5. The method according to claim 3, wherein obtaining the at least one recognition result and corresponding matching weight by analyzing subgroup attributes being segmented comprises:
differentiating the subgroup attributes using a classification model to obtain characteristics matching the subgroup attributes in the classification model; and
obtaining the at least one recognition result of the subgroup attributes and the corresponding matching weight between the at least one recognition result and the subgroup attributes according to the characteristics.

6. The method according to claim 3 or 5, wherein obtaining the at least one recognition result and corresponding matching weight by analyzing subgroup attributes being segmented comprises:
calculating frequency of the appearance of each of the subgroup attributes and number of members using each of the subgroup attributes;
carrying out a weighted aggregation to obtain degree of weighted aggregation for each of the subgroup attributes based on the frequency of appearance of the group attribute and the number of members using the group attribute; and
extracting one or more subgroup attributes with their degrees of weighted aggregation exceeding a threshold as the at least one recognition results, and
extracting the degree of weighted aggregation of the at least one subgroup attribute extracted as the corresponding matching weight.

7. The method according to claim 3, wherein extracting the at least one recognition result according to the corresponding matching weight and mapping the at least one recognition result extracted to the relationship circle comprises:
extracting one or more subgroup attributes with the largest matching weights as the at least one recognition result; and
mapping the at least one recognition result to the relationship circle as an attribute label and/or name of the relationship circle.

8. The method according to claim 7, wherein mapping the at least one recognition result to the relationship circle as an attribute label and/or name of the relationship circle comprises:
adding an attribute label and/or name for the relationship circle based on the at least one recognition result mapped; and
displaying the attribute label and/or name of the relationship circle to users.

9. The method according to claim 3, wherein extracting the at least one recognition result according to the corresponding matching weight and mapping the at least one recognition result extracted to the relationship circle comprises:
obtaining information regarding activities in the subgroups; and
extracting the at least one recognition result taking the information regarding activities in the subgroups as a reference.

10. A computer implemented system for processing relationship circles, comprising:
a subgroup acquisition module, configured to acquire subgroups within a relationship circle;
an extraction module, configured to extract subgroup attributes shared between members of the relationship circle from the subgroups; and
a mapping module, configured to obtain at least one recognition result by analyzing the subgroup attributes shared between members of the relationship circle and map the at least one attribute recognition result to the relationship circle.

11. The system according to claim 10, wherein the subgroup is in form of a relationship chain; a number of relationship chains exist between the members of the relationship circle; and the relationship chains comprises relationship chains existing in instant messengers and online social networks.

12. The system according to claim 10, wherein the mapping module comprises:
a word segmentation unit, configured to carry out a word segmentation processing of the subgroup attributes;
a recognition unit, configured to obtain the at least one recognition result and corresponding matching weight by analyzing subgroup attributes being segmented; and
a results mapping unit, configured to extract at least one recognition result according to the corresponding matching weight and map the at least one recognition result extracted to the relationship circle.

13. The system according to claim 12, further comprising:
a filter, configured to filter each character in the subgroup attributes being segmented using a noise database and carry out a fuzzy filtering of the subgroup attributes being filtered.

14. The system according to claim 12, wherein the recognition unit is further configured to differentiate the subgroup attributes using a classification model to obtain characteristics matching the subgroup attributes in the classification model and obtain the at least one recognition result of the subgroup attributes and the corresponding matching weight between the at least one recognition result and the subgroup attributes according to the characteristics.

15. The system according to claim 12 or 14, wherein the recognition unit comprises:
an arithmetic unit, configured to calculate frequency of appearance of each of the subgroup attributes and number of members using each of the subgroup attributes;
a weighted aggregation unit, configured to carry out a weighted aggregation to obtain degree of weighted aggregation for each of the subgroup attributes based on the frequency of appearance of the group attribute and the number of members using the group attribute; and
an extraction unit, configured to extract one or more subgroup attributes with their degrees of weighted aggregation exceeding a threshold as the at least one recognition results, and to extract the degree of weighted aggregation of the at least one subgroup attribute extracted as the corresponding matching weight.

16. The system according to claim 12, wherein the results mapping unit is further configured to extract one or more subgroup attributes with the largest matching weights as the at least one recognition result and map the at least one recognition result to the relationship circle as an attribute label and/or name of the relationship circle.

17. The system according to claim 16, wherein the results mapping unit is further configured to add the attribute label and/or name for the relationship circle based on the at least one recognition result mapped and display the attribute label and/or name of the relationship circle to users.

18. The system according to claim 12, wherein the results mapping unit is further configured to obtain information regarding activities in the subgroups and extract the at least one recognition result taking the information regarding activities in the subgroups as a reference.

19. A computer readable storage medium, comprising one or more programs; wherein the one or more programs are executed by one or more processors to perform a method for processing relationship circles; the method comprising:
acquiring subgroups from the relationship circle;
extracting subgroup attributes shared between members of the relationship circle from the subgroups;
obtaining at least one recognition result from the subgroup attributes shared between members of the relationship circle; and
mapping the at least one recognition result to the relationship circle.

20. The computer readable storage medium according to claim 19, wherein obtaining at least one recognition result from the subgroup attributes shared between members of the relationship circle; and mapping the at least one recognition result to the relationship circle comprises:
carrying out a word segmentation process on the subgroup attributes;
obtaining the at least one recognition result and corresponding matching weight by analyzing subgroup attributes being segmented;
extracting at least one recognition result according to the corresponding matching weight; and
mapping the at least one recognition result extracted to the relationship circle.
